(19) United States
(12) Patent Application Publication
(10) Pub. No.: US 2026/0021909 A1
(43) Pub. Date: Jan. 22, 2026

(54) SPACECRAFT PROPELLANT TANK AND ITS APPLICATION METHOD

(71) Applicant: Steamjet Space Systems, Ltd., Birmingham (GB)

(72) Inventors: Vladimir V. FEDOROV, Novosibirsk (RU); Marco PAVAN, Coventry (GB)

(21) Appl. No.: 18/778,459

(22) Filed: Jul. 19, 2024

(51) Int. Cl. B64G 1/40; F17C 1/00; F17C 5/02; F17C 5/06; F17C 7/02; F17C 13/04

(52) U.S. Cl. CPC B64G 1/4021; F17C 1/005; F17C 5/06; F17C 7/02; F17C 2201/0147; F17C 2203/0607; F17C 2221/03; F17C 2227/0192; F17C 2265/066; F17C 2270/0194

(57) ABSTRACT

The invention concerns a spacecraft propellant tank designed for storing and supplying fuel to the propulsion system, as well as its application method, which is related to space technology and particularly to the design of tanks for storing liquid propellants within rocket engines. The tank in question comprises a body featuring at least one convex edge that creates a corner capillary and an intake port positioned on one of these convex edges. Additionally, the tank's interior surface is treated to be hydrophilic. The objective of this invention is to develop a spacecraft propellant tank characterized by its lightweight and straightforward design. It facilitates the creation of various propellant tank shapes while minimizing the quantity of internal components that reduce useful volume. It also ensures consistent and reliable functionality of the propellant system with continuous supply of propellant to the intake port, even in the absence of gravity and during multiple activations of the propulsion system. The claimed invention achieves its objective by implementing technical results that include enhancing the efficiency of propellant supply within the tank to the intake port, improving reliability, augmenting the useful internal volume, and offering a variety of tank shapes. The stated objectives are met in particular through the hydrophilic properties of the propellant tank's inner surface, the design of the propellant tank shape featuring at least one convex edge that forms a corner capillary, and positioning of the intake port on one of the convex edges that forms the corner capillary. The application method for the spacecraft propellant tank involves initially filling the tank with liquid propellant and pressurizing gas through the intake port prior to spacecraft launch. Subsequently, once the spacecraft is in orbit, propellant is conveyed from the tank to the propulsion system through the intake port. The movement of liquid propellant towards the intake port is facilitated by the pressure of the pressurizing gas and a localized pressure reduction generated during propellant discharge. This reduction occurs in the corner capillary near the intake port relative to the pressure of the propellant in other sections of at least one corner capillary, thus establishing a flow of propellant through the corner capillaries towards the intake port area.

### FIELD OF THE INVENTION

The present invention relates to space technology, specifically addressing the design of spacecraft propellant tanks for storing liquid propellant in rocket engines.

### DESCRIPTION OF THE PRIOR ART

To date, a variety of propellant tanks with complex inlet designs have been developed for storing and supplying liquid propellant to spacecraft propulsion systems. During spacecraft operation, pressurizing gas is supplied to the propellant tank, and in conditions of weightlessness, the liquid propellant may not fill its entire volume and may move within the tank depending on the forces applied, making it significantly more difficult to supply the liquid propellant without pressurizing gas to the intake device and to provide its constant, non-intermittent supply to the engine. If the pressurizing gas enters the engine with the propellant, it can cause erratic operation and inconsistent thrust, which can adversely affect the spacecraft attitude control. Additionally, if there is no propellant at the inlet or inlet port when the thruster is started, pressurized gas will enter the thruster resulting in reduced maneuverability of the spacecraft or even a complete loss of attitude control.

To prevent interruptions in propellant supply to the thruster, various components and structures are used to control the positioning and intake of propellant. These components and structures are based on surface tension and capillary effects and utilize spherical or cylindrical tank designs. One popular solution involves using propellant tanks with separating membranes. These devices ensure a continuous flow of propellant to the intake device or maintain a stable volume of propellant in the intake device. However, configuring the propellant tank in this way can significantly increase the spacecraft weight and reduce its reliability due to additional components and structures, increasing the likelihood of system failure. Each added component has its own reliability characteristic and adds to the number of connections between system components. Therefore, the failure of a single component can reduce efficiency or compromise the functionality of the entire system. Furthermore, components inside the propellant tanks take up useful space that could otherwise be used for the propellant itself. This is a crucial factor in designing propellant tanks and systems for small satellites, as it also adds to the overall weight of the system, leading to increased propellant consumption. These designs may also restrict the possible embodiments of propellant tanks, which affects the possible locations of such tanks within the limited space in satellites, in which the available space for propellant tanks may be of a specific shape. This can reduce the effectiveness and suitability of such tanks in small satellites, such as CubeSats. To address these issues, propellant tanks are developed that do not require separating membranes.

The patent application RU 2657137 C2 (published 8 Jun. 2018; IPC: B64G 1/40) describes a propellant tank that includes an intake and a phase separating device. The intake device consists of a body with a T-shaped rib, a support ring, a cylindrical side wall, side posts, and an outer longitudinal rod. The support ring of the body is secured to the rib shelf, while the side wall is fixed to the support ring and covered with a protective cover. The side posts are evenly spaced around the body's side wall. The intake device comprises a splitter and an inner longitudinal rod. The phase separating device comprises the first and second screens shaped like truncated cones, connected to each other by large bases via a spacer positioned at a distance from the propellant tank shell. A smaller base of the first screen is coupled to the support ring, a smaller base of the second screen is secured to the outer longitudinal rod of the intake device. Between the screens of the phase separating device, there are meridional plates fixed on the spacer of the phase separating device and the side posts of the intake body.

This invention has some disadvantages, such as the use of in-tank baffles and a phase-separating device to ensure uninterrupted propellant flow to the intake port. Additionally, the heads of the propellant tank, including the intake device, must be hemispherical in shape. However, the use of additional components and structures can significantly impact the reliability of the device, reduce the useful volume inside the propellant tank, limit the possibility of implementing the necessary shapes, and increase the weight of the entire system, making it unsuitable for small satellites.

The utility model RU7088U1 (published: 16.07.1998; IPC: B64G 1/40) describes a propellant tank for storing and supplying liquid propellant under weightlessness conditions. The tank consists of a shell, a filling and draining nozzle, a mesh propellant intake coaxially aligned with the draining nozzle, meridionally arranged capillary feed components installed perpendicular to each other on the inner surface of the shell, and rigid baffles evenly arranged on the inner surface of the shell between the capillary feed components in mutually perpendicular directions around the intake. The propellant tank features an intake in the shape of a truncated cone, positioned with its smaller base on the inner surface of the tank shell. The tank head is installed on the larger base and on the free ends of the baffles. The capillary feed components are designed as V-shaped troughs, and the mesh size of the intake grid increases in the direction of liquid discharge.

This invention has the disadvantage of using capillary feed components, mesh cone intake, and other components. These components reduce the useful volume inside the propellant tank, reduce its reliability, constrain potential embodiments of the propellant tank, and add weight, making it unsuitable for applications such as small satellites.

Patent CN111776252A (published: 16.10.2020; IPC: B64G 1/40; B05D 5/00; C25D 5/02) describes a functional surface for a guide plate of a simulated de Laval nozzle design characterized in that it includes a guide plate surface and multiple guide gratings which are uniformly arranged on the guide plate surface; the guide plate surface is a super hydrophilic surface; the guide plate surface includes a plurality of uniformly arranged structural blocks with superhydrophobic surfaces; the surface of the guide plate between adjacent guide gratings that are perpendicular to the guide plate flow direction has the shape with a cross section of a de Laval nozzle; and the cross section of the guide plate gradually tapers in width along the guide plate flow direction.

The disadvantages of this invention include the use of guide plates, which are challenging to manufacture and increase the number of components inside the propellant tank, thereby reducing its reliability and useful volume, as well as limiting its potential embodiments and increasing the weight of the entire structure, which may not be suitable for applications such as small satellites.

Patent US2012024135555A1 (published: 27 Sep. 2012; IPC: B65D 85/00; B23P 17/00; B01D 53/04) describes a removable satellite propellant supply system consisting of a sealed aluminum alloy tank containing a propellant management device, also made of aluminum alloy. The propellant management device (PMD) is capable of using any surface-tension-based capillary action liquid transport means known in the art. The tank and PMD's internal surfaces are coated with a titanium-based material using plasma-powder spraying, which guarantees propellant wettability and corrosion resistance of the propellant supply system.

The disadvantages of this analog are that it also uses guide vanes and a special sponge, which increases the weight of the propellant tank and complicates its design. This compromises the reliability of the analog, reduces its useful internal volume and limits the possible embodiments. The analog also describes coating the inner surface of the tank and all internal structures of the propellant management device with a thin layer of titanium-based coating to improve wettability and corrosion resistance. However, the titanium coating may not be sufficiently hydrophilic for certain spacecraft propellants.

U.S. Pat. No. 3,854,905A (published: 17.12.1974; IPC: B01D 53/00) describes a storage device for continuously supplying a selected one of two fluids from a storage device on demand until the selected fluid is substantially exhausted, where the said selected fluid is a liquid, and comprises: a closed storage container having an inner surface; a first opening for inletting fluids into said container; a second opening for discharging the said selected liquid from the said container; and means for providing a continuous flow path for the said selected liquid; the said means includes an elongated element that is generally flat in the said container, located adjacent to the said inner surface and extending in the direction of the said second opening, the said element being arranged along the said inner surface to form an angle with a part of the surface of the said element and a part of the inner surface to support the path of the liquid flow, when the liquid in the said container is depleted; the said inner surface and the surface of the said element is formed of a material which is preferentially wetted by the said selected liquid, whereby the said flow path of only the said selected liquid to the said second opening is constantly maintained; when the said selected liquid is depleted from the said device, the liquid flows to the said second opening along the channel formed by capillary action at the said corner of the said element and the said inner surface; the respective densities of the said two liquids are selected so that the flow of the said selected liquid is substantially independent of the mass forces acting on the said device subjected to acceleration fields.

The disadvantages of this analog are that it also uses special curved surfaces that are rounded towards the tank surface, as guides for the movement of the propellant in the tank towards the inlet device or the perforated opening using capillary forces, which also increases the complexity of the tank manufacturing, reduces its reliability and useful internal volume, limits possible realizations of its shape, and increases its weight, which may not be suitable, for example, for small satellites. The analog does not use hydrophilic coatings, and the wettability of the propellant is achieved only by selecting optimal propellants and pressurizing fluids, which can also make the structure more expensive or heavier, and limit the choice of propellants and pressurizing media.

The disadvantages of the aforementioned inventions are the use of various additional structures for uninterrupted propellant supply to the intake port or device, which increases the weight of the spacecraft and reduces its useful internal volume. Additionally, all the above systems have complex designs, which significantly reduces the reliability of the propellant tanks, posing challenges for small satellites, for example, CubeSats. In addition, the design features do not allow the shape of the propellant tank to be varied.

Existing propellant tanks, while providing varying degrees of stability in propellant supply from the tank to the thruster, require complex manufacturing and/or rely on technology designed for larger spacecraft, making them unsuitable for smaller satellites like CubeSats. Consequently, there is a demand for low cost and lightweight propellant tanks with stable propellant supply to the thruster.

### SUMMARY OF THE INVENTION

The objective of the present invention is to develop a spacecraft propellant tank that is lightweight, has a simple design, and allows for a wide range of tank shapes with minimal internal components taking up useful volume. It should also ensure reliable operation of the propellant system and uninterrupted propellant supply to the intake port even in zero-gravity conditions and during multiple starts of the propulsion system. This objective is accomplished by the claimed invention through achieving the technical results consisting in increasing the efficiency of propellant supply inside the propellant tank to the intake port, increasing its reliability, increasing the useful internal volume and broadening shape options. These objectives are also achieved through:
the hydrophilic properties of the inner surface of the propellant tank, the
the design of the propellant tank shape with at least one convex edge forming a corner capillary, and
the location of the intake port on one of the convex edges forming the corner capillary.

Specifically, the spacecraft propellant tank achieves its technical result through a tank body featuring at least one convex edge forming a corner capillary and an intake port positioned on one of these convex edges, wherein the inner surface of the tank is made hydrophilic to ensure its wettability with propellant.

The tank can adopt any shape but must include at least one convex edge forming a corner capillary which allows the propellant to move to the intake port to be introduced into the propulsion system via surface tension forces, pressure differences in the propellant and gas, and the capillary effect. A convex edge is an edge formed at the intersection of two surfaces where the angle at which these surfaces intersect on the interior side of the tank is less than 180 degrees. A corner capillary is also considered a convex edge if its angle is less than the difference between 180 degrees and the double wetting angle. The wetting angle formed between the surface of a liquid and a solid determines the degree of wettability of liquids on certain solid surfaces. A coating is considered hydrophilic if its wetting angle with the selected liquid is less than 90°. The higher the wettability, the smaller the wetting angle.

Before start, the tank is filled with liquid working mass (hereinafter referred to as liquid or propellant) and pressurizing gas, which serves for subsequent expulsion of this liquid from the tank. After the active phase of the satellite launch into a given orbit and transition to microgravity conditions, the liquid covers the entire inner hydrophilic surface of the tank due to wetting. The pressurizing gas takes the form of a plurality of spherically shaped bubbles of various sizes within this liquid. As the liquid is expended from the tank, the volume and size of the spherical pressurizing gas bubbles increases. When a significant volume of liquid is consumed, the bubbles will fill the inner volume of the tank, start to contact each other and deform, which will cause them to merge and form a single gas volume inside the tank, while the liquid will remain in the corner capillaries. The shape of the interface between the liquid and the pressurizing gas will be a concave meniscus. The pressure difference between the gas and the liquid will be determined by the curvature radius of this concave meniscus, the larger the radius of curvature of the meniscus, the smaller the pressure drop. The intake port is located on one of the convex edges and thus, at the next extraction of the liquid through the intake port, there will be less liquid in the vicinity of the port, the local radius of curvature of the meniscus will correspondingly decrease, which will result in a local drop in liquid pressure relative to the liquid pressure in other areas of the corner capillaries. Due to the resulting pressure drop, the liquid will flow through the corner capillaries into the area of the intake port. This will continue until all connected corner capillaries are completely drained of liquid without the use of additional structures and components. The selected inner surface of the propellant tank must be of a type that will be wetted by the propellant. The corner capillaries formed by the convex edges within the propellant tank provide a pathway for the propellant from which, due to capillary forces, it does not escape under external effects such as vibration, acceleration, and so on, typical of microsatellites in orbit, such as CubSats, and tend to return the liquid to its original position.

Geometric constrains prevent spherical bubbles from covering the intake port located in the corner capillary. The sharper the angle of the convex edge forming the corner capillary at the location of the intake port and the smaller the characteristic size of the intake port, the smaller the size of the bubble that is able to reach this intake port. In one embodiment of the propellant tank, the intake port may be positioned at the intersection of the corner capillaries if multiple capillaries are present. This allows for the liquid to be discharged from the tank under the pressure of the pressurizing gas when commanded by the propulsion system. The liquid exits with little or no gas, but microbubbles of pressurizing gas and dissolved pressurizing gas may exit with the liquid, having negligible impact on the operation of most small satellite propulsion systems.

In one particular embodiment, the present invention includes a tank body having an interior surface that is hydrophilic, shaped as a cube with corners tapered toward the apex with a phase-separating intake device and an intake port, whose corner capillaries provide a continuous path for propellant to the intake and V-shaped channels.

The invention further claims a method for applying the spacecraft propellant tank to achieve technical objectives.

Initially, the propellant tank is filled with liquid propellant and pressurizing gas through the intake port prior to spacecraft launch;

Once the spacecraft is in orbit, the propulsion system is supplied with propellant from the propellant tank through the intake port. The liquid propellant is directed to the intake port by the pressure of the pressurizing gas and the local pressure drop in the corner capillary created during propellant discharge in the area of the intake port relative to the pressure of the propellant in other areas of at least one corner capillary. This forms a propellant flow through the corner capillaries into the area of the intake port.

The method is distinguished by the additional supply of propellant to the propulsion system through an intake port equipped with a phase-separating intake device.

Moreover, the method is characterized by the supply of the propellant to the propulsion system through multiple corner capillaries that intersect directly or through other capillaries, if multiple corner capillaries exist.

Additionally, the method is characterized by the supply of the propellant to the propulsion system through an intake port located at the apex of the propellant tank, which is formed by at least two convex edges that create corner capillaries.

### DESCRIPTION OF THE DRAWINGS

To facilitate understanding of the invention, a more specific description of the invention briefly described above will be given with reference to specific embodiments illustrated in the accompanying drawings. The accompanying drawings illustrate only embodiments of the invention and should not be regarded as limiting the scope of the invention, but further particulars and details of aspects of the invention will be described and explained.

The object of the claims under the present patent application is described item by item and clearly stated in the Claims. The objectives, features, and advantages of the invention are evident from the detailed description and accompanying drawings:

FIG. 1 shows a schematic representation of the propellant tank having a single convex edge forming a corner capillary according to the present invention.

FIG. 2 shows a schematic representation of the propellant tank of FIG. 1 (side view) according to the present invention.

FIG. 3 shows a schematic representation of one possible embodiment of the propellant tank in the shape of a cube according to the present invention.

FIG. 4 shows a schematic representation of one possible embodiment of the propellant tank in the shape of a pyramid according to the present invention.

FIG. 5 shows a schematic representation of one possible embodiment of the propellant tank of cylindrical shape with a drop-shaped cross-section according to the present invention.

FIG. 6 shows a schematic representation of a propellant tank area with a corner capillary where the propellant forms a meniscus.

FIG. 7 shows a schematic representation of the propellant tank with V-shaped channels, with corner capillaries tapered toward the intake port and with the intake device upstream of the intake port according to the present invention.

FIG. 8 shows a block diagram illustrating a method of applying the spacecraft propellant tank according to the present invention.

Said drawings are clarified by the following items: Propellant tank body—1; Intake port—2; Convex edges—3; Corner capillary—4; Phase separating intake device—5; V-shaped channels—6; Liquid propellant—7; Pressurizing gas—8; Propellant tank—100.

### DETAILED DESCRIPTION

The following description of an embodiment of the invention provides implementation details to facilitate a clear understanding of the invention. However, it is apparent to those skilled in the art how the present invention can be used with or without these implementation details. In some cases, well-known methods, procedures and components are not described in detail to avoid impeding the understanding of the features of the present invention.

Furthermore, it is clear from the foregoing that the invention is not limited to the embodiment shown. Those skilled in the art will recognize numerous possible modifications, alterations, variations and substitutions while retaining the essence and form of the presented invention.

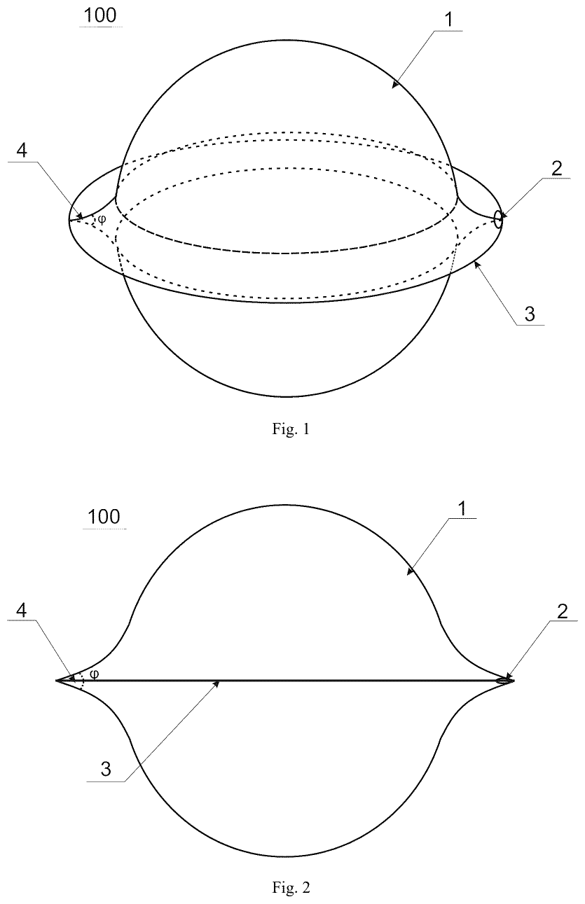

FIGS. 1 and 2 show a schematic representation of the propellant tank 100 according to the present invention. A spacecraft propellant tank 100 having a hydrophilic inner surface for storing and supplying propellant to a propulsion system comprises a tank body 1 which is made with at least one convex edge 3 forming a corner capillary 4 and an intake port 2 located on one of these convex edges 3.

Prior to launch, the tank is filled with liquid propellant 7 and pressurizing gas 8 to subsequently displace this propellant 7 from the tank 100. The proportions of the filling and the tank 100 are determined by the characteristics of the satellite's propulsion system. Under gravity conditions, propellant 7 occupies the lower part of the tank and pressurizing gas 8 occupies the upper part. When, upon completing the active phase of launch, the spacecraft reaches microgravity conditions, the propellant fills the entire inner hydrophilic surface of tank 1 due to wetting. At the same time, the pressurizing gas 8 takes the form of a plurality of spherically shaped bubbles of various sizes within the propellant 7 due to surface tension forces. As the propellant 7 is expended from the tank 100, the volume, and thus, the size of the spherical pressurizing gas bubbles 8 increases. When a substantial volume of propellant 7 has been consumed, the bubbles fill the interior volume of tank 100 and begin to contact each other and deform, which causes them to merge and eventually form a single gas volume within tank 100, while propellant 7 remains in corner capillaries 4. The interface between propellant 7 and pressurizing gas 8 adopts a concave meniscus shape. The pressure difference between pressurizing gas 8 and propellant 7 is determined by the radius of curvature of this concave meniscus, the larger the radius of curvature of the meniscus, the smaller the pressure drop. The meniscus curvature radius is determined by the amount of liquid propellant 7 in corner capillary 4 formed by convex edge 3 and the wetting angle. Intake port 2 is located on one of such convex edges 3 and thus, the next time propellant 7 is pumped through the intake port 2, there will be less propellant 7 near this port, the local radius of the meniscus curvature will correspondingly decrease causing a local drop in the pressure of propellant 7 relative to the pressure of propellant 7 in other areas of corner capillaries 4. The resulting pressure drop will form a flow of propellant 7 through the corner capillaries 4 into the area of the intake port 2. This process continues until the propellant 7 is completely drained from all connected corner capillaries 4 without requiring additional structures or components. The selected inner surface of the propellant tank 1 should be of a type that will be wetted by the propellant 7. Corner capillaries 4, formed by convex edges 3 within the propellant tank 100, provide a pathway for the propellant from which, due to capillary forces, it does not escape under external effects such as vibration, acceleration, and so on, typical of microsatellites in orbit, such as CubSats, and tend to return propellant 7 to its original position. This increases the efficiency of propellant 7 supply to intake port 2 due to the stability of propellant in capillaries 4 to external effects. The absence of additional structures increases the useful volume of the tank, its reliability, and allows for a wide choice of implementations of the shapes of propellant tank 100, which directly contribute to achieving technical objectives.

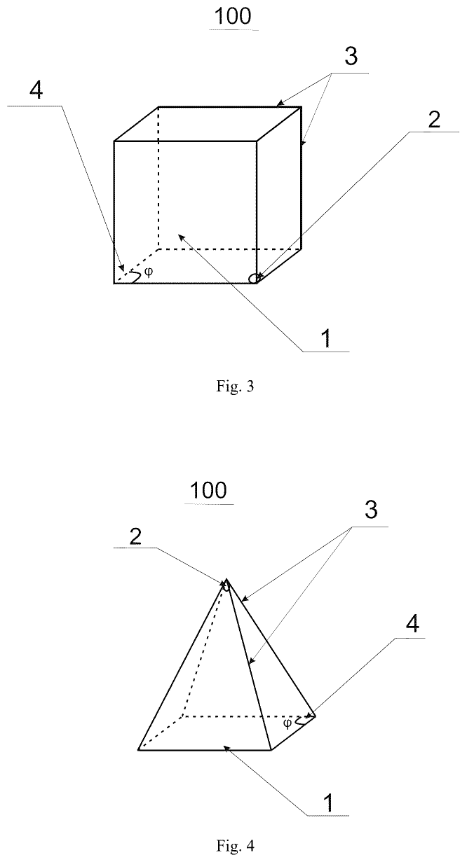

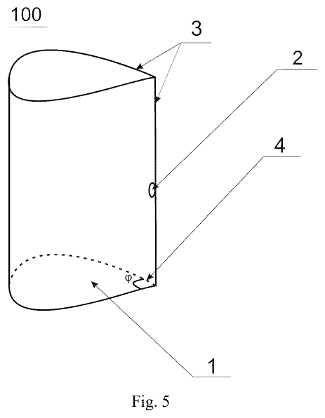

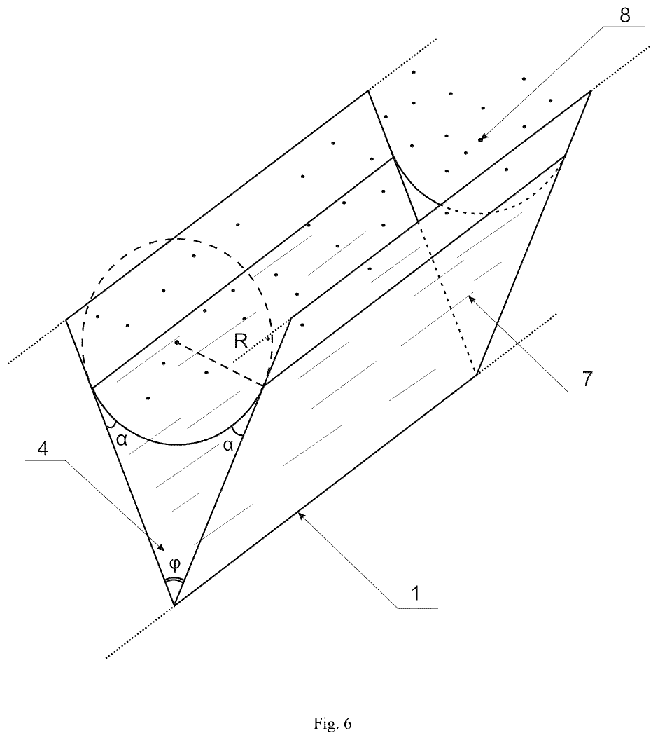

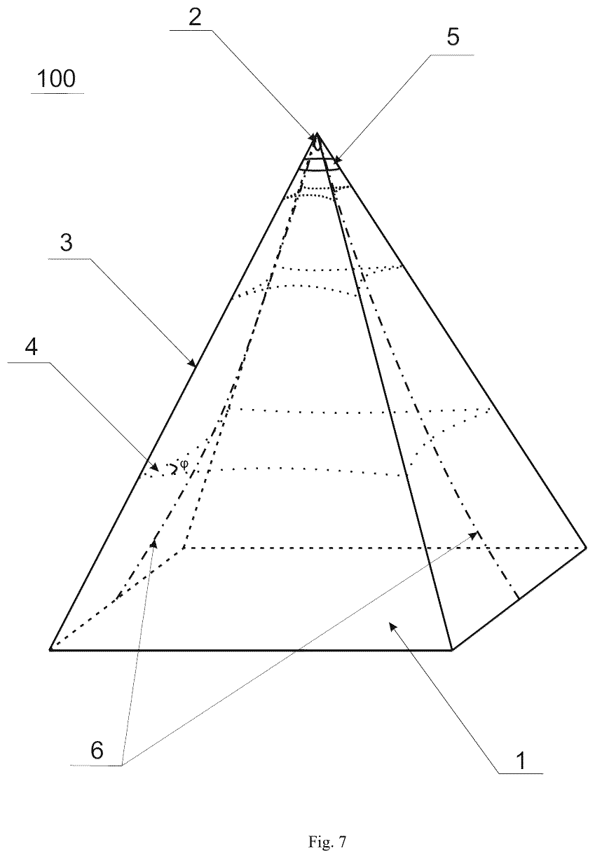

The propellant tank body 1 is necessary for storing and supplying the propellant 9 and can be constructed from various materials commonly used in spacecraft construction, such as aluminum, stainless steel, titanium and so on, while a hydrophilic material may be selected depending on the propellant used. However, the material may vary depending on the purposes for which the spacecraft is used. The propellant tank body 1 is shaped so that at least one convex edge 3 forms a corner capillary 4, wherein propellant, at low quantities, forms a concave meniscus, as shown in FIG. 6. The pressure difference between the pressurizing gas 8 and propellant 7 is determined by the curvature radius R of this concave meniscus; the larger the radius of curvature of the meniscus, the smaller the pressure drop. In this case, the radius of curvature of the meniscus is determined by the propellant amount and the wettability of the inner surface of the propellant tank body 1. As stated above, an edge 3 is convex if formed by the intersection of two surfaces of propellant tank body 1 at an angle of less than 180 degrees on the inner side of the tank 1. A corner inside the propellant tank body 1 is a corner capillary 4 if it is formed by a convex edge whose angle is less than the difference between 180 degrees and the double wetting angle, which is expressed by the formula:

$$φ < {180}^{∘} - 2 α ,$$

where (p is the value of the convex edge angle, a is the angle of wetting of the solid surface by the liquid. When propellant is discharged from tank 100, the corner capillary 4 itself forms the path through which propellant 7 moves toward intake port 2 or, in a particular embodiment of the invention, toward phase separation intake device 5. This configuration provides for efficient delivery of propellant 7 without additional internal components and allows the propellant tank 100 to be made in a wide variety of different shapes with any number of convex edges 3 forming corner capillaries 4, since the selection of shapes is limited only by the features listed above. At the same time, capillary forces in corner capillaries 4 counteract external effects, such as vibration, acceleration and so on, typical of microsatellites in orbit. Examples of embodiments of propellant tank body 1 are shown in FIGS. 3 to 5. Also, it is additionally possible to taper corner capillaries 4 toward intake port 2, as shown in FIG. 7, where propellant tank 100 has a pyramid shape with curved side surfaces (the pyramid cross-sections are indicated by dashed lines), whereby the corner capillaries taper toward intake port 2. In this case, the propellant is more effectively moved by capillary forces towards intake port 2 and gas bubbles are better cut off in it, which increases the efficiency of propellant delivery.

FIGS. 1 and 2 show an example embodiment of propellant tank 100 with a hydrophilic inner surface made in a shape with a single convex edge 3 forming corner capillary 4, and intake port 2 located on this convex edge 3.

When propellant 7 is discharged from the propellant tank 100 through intake port 2, the amount of propellant near the port is reduced, thereby reducing the local curvature radius R of the meniscus in the corner capillary 4. The change of the meniscus curvature radius leads to a local drop in propellant 7 pressure in this area relative to the propellant pressure in other areas of corner capillary 4, the pressure drop creates forces seeking to equalize this pressure drop and causing the propellant to flow over corner capillary 4 towards intake port 2. This thereby ensures a low residual mass of unspent propellant 7, which also affects the efficiency of propellant delivery from the propellant tank 100. For a propellant tank shape with more than one edge 3, corner capillaries 4 may additionally form a continuous path for propellant 7 to intake port 2 or intake device 5, that is, all corner capillaries 4 must intersect each other directly or be interconnected via other capillaries 4. Thereby propellant will flow from all corner capillaries 4 of the propellant tank 100 to intake port 2 or intake device 5, as in this case corner capillaries 4 act as communicating vessels due to the same pressure of pressurizing gas 8 in all regions within the propellant tank body 1. FIGS. 3-5 show propellant tanks 100 of different shapes and configurations, and with varying numbers of convex edges 3. Examples of shapes with convex edges 3 forming corner capillaries 4 within a propellant tank body 1 are a cube, a pyramid or a cylindrical shape with a water drop-shaped cross-section shown in FIGS. 3-5, whose edges 3 and corner capillaries are all interconnected and provide a continuous path for the propellant to intake port 2. The choice of the shape of the propellant tank 100, the number of convex edges 6, and the values of their angles for forming corner capillaries 4 depends on the required parameters and are evident to persons skilled in the art.

The intake port 2 is provided for supplying propellant 7 from the propellant tank 100 to the propellant line leading to the spacecraft thruster (not shown), and for filling the propellant tank 100 with propellant 7 and pressurizing gas 8. During the pulsed operation mode of the thruster, a certain amount of propellant passes through intake port 2 at certain time intervals with a certain frequency, depending on the thruster operation mode. The modes of thruster operation, the amount and timing of propellant discharge through the propellant intake port 2, and the methods of controlling the supply are apparent to persons skilled in the art. For example, the propellant supply may be regulated by controlled valves in the propellant line, controlled flow devices, or other devices known in the prior art. In order for propellant 7 to be supplied to intake port 2 or intake device 5, it must be positioned on the very edge 6 forming corner capillary 4, since in this case propellant 7 will move along the capillary path by the mechanism described above. Due to geometric constraints, spherical bubbles of pressurizing gas 8 cannot block intake port 2 located in corner capillary 4. Spherical bubbles tend to retain their spherical shape due to surface tension, therefore if their size exceeds the size of intake port 2 located in convex edge 3 and the speed of liquid supply to port 2 is insufficient to significantly deform the bubbles, the bubbles cannot enter said port 2. In the simplest case for a circular intake port 2, no bubbles with a diameter larger than this port 2 will enter. If port 2 is shaped as a slit, no bubbles with a diameter larger than the width of this slit will enter. The sharper the angle of the convex edge 3 forming corner capillary at the location of intake port 2 and the smaller the characteristic size of intake port 2, the smaller the size of the bubble able to reach this intake port. If the propellant tank body 1 is shaped to have intersections of at least two convex edges 3 forming corner capillaries 4, intake port 2 may be located at the thus formed apex of the propellant tank body 1, for example it may be one of the apexes of a cube-shaped propellant tank 100 as shown in FIG. 3. This reduces the mass of unspent propellant 7 and helps trap gas bubbles near the intake port, thus increasing the efficiency of propellant supply from the propellant tank 100.

In one embodiment, the propellant tank may also contain a phase-separating intake device 5 designed to reduce the likelihood of gas bubbles entering intake port 2 (FIG. 7) and to detain the microbubbles and pressurizing gas 8 dissolved in propellant 7. It can be designed as a cylinder of porous material or as a mesh intake, which due to the surface tension forces of the wetted cells will prevent the passage of gas bubbles entrapped in propellant 7. It is positioned in front of and completely covers intake port 2 further preventing contamination of propellant 7 by pressurizing gas 8, thereby increasing the efficiency of propellant delivery to the propulsion system and ensuring efficient operation. Other embodiments of the phase separation intake device 5, its shape and other parameters depend on the type of propellant 7 and are apparent to persons skilled in the art.

The inner surface of tank 1 is made hydrophilic. In one embodiment, the propellant tank body 1 itself is made of hydrophilic materials. In another possible embodiment, the inner surface of the propellant tank body 1 is coated with a layer of hydrophilic material. The materials which the propellant tank body 1 is made of or its inner surface is coated with are selected on the basis of propellant 7 used to ensure sufficient wettability of the inner surface. This is necessary for forming corner capillaries 2, in which capillary forces counteract external effects, such as vibration or acceleration, typical of microsatellites in orbit, and to maintain the position of the liquid within them. This directly affects the retention of propellant position in corner capillaries 4 of the propellant tank 1; consequently, it influences the liquid flow through these capillaries, which provide a smooth supply of propellant 7 to intake port 2 or intake device 5; this, in turn, directly affects the achievement of the stated technical result. Further, the propellant tank 100 supplies propellant 7 to the intake port without the use of additional components and structures, which increases the useful internal volume of the propellant tank 100 and reduces its weight, resulting in lower propellant consumption. Further, due to the absence of additional components, their fasteners and the like, the reliability of the propellant tank 100 is increased, since the additional components weaken the structure at the connection points, increase the likelihood of propellant 7 leakage, and possess their own degree of reliability; their malfunction may lead to a failure of the entire propellant tank 100 or reduce its efficiency. The choice of materials of propellant tank body 100 or its inner coating making the inner surface hydrophilic depends on the propellant used. Titanium or zirconium dioxide, zinc oxide, organic polymers containing isocyanate groups and other materials known in the art may be used as hydrophilic materials to produce the inner surface of propellant tank 100 or the entire body of propellant tank 100; the surface may also be made rough to enhance its hydrophilic properties. The choice of materials and their properties are obvious to persons skilled in the art.

In addition, the inner surface of the propellant tank 100 may include V-shaped channels 6 leading to the intake port (FIG. 7, indicated by a dashed line). They may be used as additional smaller capillaries leading to intake port 2 or phase separation intake device 5, thereby reducing the mass of unspent propellant 7 further increasing the efficiency of the supply of propellant 7 to the intake port. Their surfaces are also made hydrophilic. The angle of V-shaped channel 6 depends on propellant 9 used and the degree of wettability of the inner surface of the propellant tank body 1; the depth depends on the wall thickness of the propellant tank body 1.

It is important to note that any additional spacecraft propellant tank components described above may be utilized in the tank individually, concurrently, or in any combination. An embodiment of a spacecraft propellant tank with any additional component will lead to the achievement of additional technical results described in the application along with the main technical result. Further, any of the additional features of the tank may be interpreted as an additional feature of the method of application of the spacecraft propellant tank. Similarly, any of the additional features of the tank application method may be interpreted as an additional feature of the spacecraft propellant tank design.

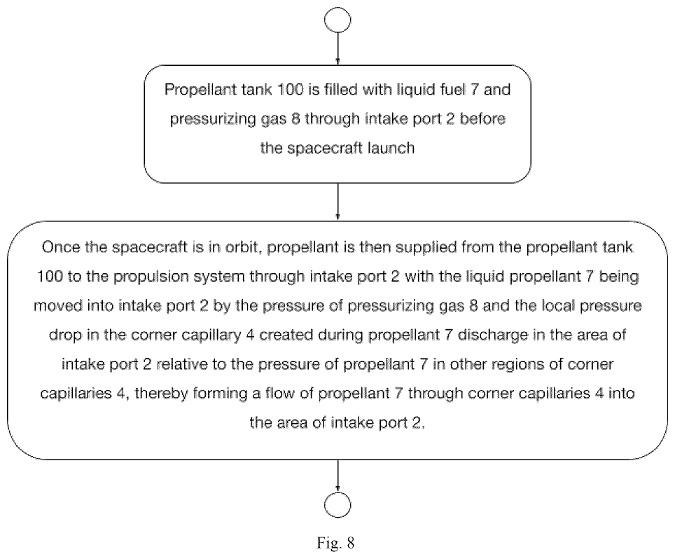

FIG. 8 is a block diagram illustrating a method of application of the spacecraft propellant tank. According thereto, the propellant tank 100 is first filled with liquid propellant 7 and pressurizing gas 8 through intake port 2 before the spacecraft is launched;

After the spacecraft has been placed into orbit, propellant is then supplied from the propellant tank 100 to the propulsion system through intake port 2 with the liquid propellant 7 being moved into intake port 2 by the pressure of pressurizing gas 8 and the local pressure drop in corner capillary 4 created during propellant 7 discharge in the area of intake port 2 relative to the pressure of propellant 7 in other regions of corner capillaries 4, thereby forming a flow of propellant 7 through corner capillaries 4 into the area of intake port 2.

Additionally, propellant 7 is fed into the propulsion system through intake port 2 equipped with a phase separating intake device 5 to further clean propellant 7 from gas bubbles.

Additionally, when there is more than one corner capillary 4, propellant 7 is supplied to the propulsion system via a plurality of corner capillaries 4 made to intersect each other directly or connected via other capillaries 4 to reduce the amount of unspent propellant 7.

Additionally, propellant 7 is fed to the propulsion system through intake port 2 located at the apex of the propellant tank 100 formed by at least two convex edges 3 forming corner capillaries 4 to further clean propellant 7 from gas bubbles and reduce the mass of unspent propellant 7.

In one of the best embodiments presented herein, the propellant tank 100 is constructed as follows. The inner surface of the propellant tank body 1 is coated with a hydrophilic material, and body 1 itself is shaped to have a number of convex edges 3 forming corner capillaries 4 that taper towards intake port 2 to form a continuous path for propellant 7 and allow for the action of capillary forces moving propellant 7 towards the intake port. Intake port 2 itself is located at the apex of propellant tank 100 formed by at least two convex edges 3 to reduce the mass of unspent propellant 7. Furthermore, V-shaped channels 6 are present on the inner surface of the propellant tank body 1, leading to intake port 2 and forming additional capillary paths for the propellant.

The terminology used herein is intended solely to describe specific embodiments and is not to limit the present invention. Furthermore, it should be understood that the terms “comprises”, “contains” and/or “includes” when used in this specification indicate the presence of the claimed features, integer quantities, steps, operations, elements and/or components, but do not preclude the presence or addition of one or more other features, integer quantities, steps, operations, parts of components and/or groups thereof.

The respective structures, materials, acts and equivalents of all means or components of a step and function in the claims below are intended to include any structure, material or act for performing a function in combination with other claimed components as specifically claimed. The description of the present invention is provided for purposes of illustration and presentation, but is not intended to be exhaustive or limited to the invention in the form described. To persons skilled in the art, many possible modifications and variations that do not depart from the essence of the invention will be obvious. The embodiments have been selected and described to best explain the principles of the invention and its practical applications, and to enable others of ordinary skill in the art to understand the invention for various embodiments with various modifications that are suitable for the particular intended application.

Thus, the mentioned components directly affect the technical outcomes, consisting in increasing the efficiency of propellant supply inside the propellant tank to the intake port, enhancing its reliability, increasing the useful internal volume, and providing a wide choice of possible realizations of its shapes.

The present application materials disclose the preferred embodiment of the claimed technical solution, which should not be used to limit other, specific embodiments which do not go beyond the requested scope of legal protection and are obvious to persons skilled in the art.

1. A propellant tank of a spacecraft for storing and supplying propellant to a propulsion system including a tank body that is made with at least one convex edge forming a corner capillary and an intake port located on one of these convex edges; the interior surface of the tank is made hydrophilic.

2. The propellant tank according to claim 1 characterized in that the tank is additionally equipped with a phase separating intake device.

3. The propellant tank according to claim 1 characterized in that additionally, if more than one corner capillary is present, all corner capillaries intersect directly or are interconnected by other capillaries.

4. The propellant tank according to claim 1 characterized in that the intake port is located at the apex of the propellant tank formed by at least two convex edges forming corner capillaries.

5. The propellant tank according to claim 1 characterized in that the propellant tank body is made of hydrophilic materials.

6. The propellant tank according to claim 1 characterized in that the inner surface of the propellant tank body is coated with a hydrophilic material.

7. The propellant tank according to claim 1 characterized in that it further comprises internal V-shaped channels leading to the intake port.

8. The propellant tank according to claim 1 characterized in that additionally at least one corner capillary leading to the intake port is tapered.

9. A method of application of the spacecraft propellant tank, wherein:
the propellant tank is filled with liquid propellant and pressurizing gas through the intake port before spacecraft launch;
after the spacecraft is placed in orbit, the propellant is supplied from the propellant tank to the propulsion system through the intake port with the liquid propellant moved into the intake port by the pressure of the pressurizing gas and the local pressure drop in the corner capillary created during propellant discharge in the area of the intake port relative to the pressure of the propellant in other areas of at least one corner capillary, thereby forming a propellant flow through the corner capillaries into the area of the intake port.

10. The method of application of the propellant tank according to claim 9 characterized in that the propellant is supplied to the propulsion system through an intake port equipped with a phase separating intake device.

11. The method of application of the propellant tank according to claim 9 characterized in that the propellant is supplied to the propulsion system through a plurality of corner capillaries intersecting directly or connected by means of other capillaries, if more than one corner capillary is present.

12. The method of application of the propellant tank according to claim 9 characterized in that the propellant is supplied to the propulsion system through an intake port located at an apex of the propellant tank formed by at least two convex edges forming corner capillaries.
